(19) United States
(12) Patent Application Publication
(10) Pub. No.: US 2019/0350038 A1
(43) Pub. Date: Nov. 14, 2019

(54) METHODS AND DEVICES FOR FACILITATING DISCONTINUOUS RECEPTION

(71) Applicant: Telefonaktiebolaget LM Ericsson (publ), Stockholm (SE)

(72) Inventors: Shaohua Li, Beijing (CN); Rui Fan, Beijing (CN); Claes Tidestav, Bålsta (SE)

(21) Appl. No.: 16/474,433

(22) PCT Filed: Jul. 7, 2017
(86) PCT No.: PCT/CN2017/092237

§ 371 Date: Jun. 27, 2019

(30) Foreign Application Priority Data
Jan. 5, 2017 (CN) PCT/CN2017/070303

(51) Int. Cl. H04W 76/28; H04L 5/00; H04W 56/00

(52) U.S. Cl. CPC H04W 76/28; H04L 5/0051; H04W 56/005; H04L 5/0092

(57) ABSTRACT

The present disclosure provides a method in an access device for facilitating Discontinuous Reception (DRX) at a terminal device. The method comprises: transmitting a signal to the terminal device before or within an on-duration of DRX, for front-end and/or synchronization adjustment at the terminal device.

### TECHNICAL FIELD

The present disclosure relates to communication technology, and more particularly, to methods and devices for facilitating Discontinuous Reception (DRX).

### BACKGROUND

In Long Term Evolution (LTE) systems, in order to save power consumption at a terminal device, or User Equipment (UE), it has been proposed to adopt a Discontinuous Reception (DRX) technique. FIG. 1 shows a basic concept of DRX. As shown, there are two cycles in DRX, a long DRX cycle (e.g., 320 ms) and a short DRX cycle (20 ms). A terminal device wakes every 320 ms for control/data signal reception. During the period in which the terminal device is awake, also referred to as “on duration”, the terminal device monitors Physical Downlink Control Channel (PDCCH). If the terminal device does not receive PDCCH within the on duration (e.g., 2 ms), it will go to sleep until the next on duration. On the other hand, if the terminal device receives PDCCH within the on duration, it will keep awake for at least a period measured by a DRX-inactivity timer (e.g., 100 ms), after which it wakes every 20 ms (i.e., short DRX cycle) for signal reception until it enters another long DRX cycle.

In the LTE systems, there is an always-on Cell-specific Reference Signal (CRS). A terminal device in DRX can wake a little earlier than an on duration and rely on the CRS for front-end and/or synchronization adjustment, e.g., Automatic Gain Control (AGC) adjustment, time/frequency synchronization refinement, and/or Fast Fourier Transform (FFT) window adjustment, before it can receive control/data signals correctly in the on duration.

However, in a future wireless system, there may not be such always-on signal. Hence, the terminal device cannot rely on the CRS for front-end and/or synchronization adjustment.

Moreover, the dynamic range of the received signal in the future wireless system will be much larger than that in LTE due to narrower beamforming. In LTE, the Reference Signal Received Power (RSRP) is closely related to the distance from a UE to an access device, e.g., an evolved NodeB (eNB). The distance changes semi-statically on the order of seconds. However, the future wireless system, a beam gain varies depending not only on the distance from the UE to the eNB, but also on the angle between the UE and the eNB, which may change much faster than the distance as the UE moves. Thus, a timely AGC adjustment becomes critical for DRX in the future wireless system, especially for the long DRX cycle.

In Device-to-Device (D2D) communications, a UE may use the first Orthogonal Frequency Division Multiplexing (OFDM) symbol in the on duration for AGC and/or synchronization adjustment. However, this may not be applicable to the future wireless system where Reference Signals (RSs) are located in the first one or more symbols for latency reduction. If the first OFDM symbol is used for AGC and/or synchronization adjustment, there would be less RSs for channel estimation, resulting in significant performance degradation.

As another choice, a UE may use Primary Synchronization Signal (PSS)/Secondary Synchronization Signal (SSS)/Physical Broadcast Channel (PBCH) for AGC and/or synchronization adjustment. However, in the future wireless system, the PSS/SSS/PBCH may have different beamforming than the control/data signal transmission, which may lead to up to 10 dB deviation in AGC adjustment.

Furthermore, in DRX, it may be difficult for an access device to determine an optimal beam for communicating with a terminal device after a long DRX cycle since the movement of the terminal device may be unknown to the access device.

There is thus a need for an improved solution for DRX operations.

### SUMMARY

It is an object of the present disclosure to provide methods and devices for facilitating DRX, capable of achieving timely adjustment of front-end and/or synchronization by providing an appropriate signal design.

According to a first aspect of the present disclosure, a method in an access device for facilitating Discontinuous Reception (DRX) at a terminal device is provided. The method comprises: transmitting a signal to the terminal device before or within an on-duration of DRX, for front-end and/or synchronization adjustment at the terminal device.

In an embodiment, the signal is transmitted in the first one or more subframes within the on duration, the first one or more subframes having a first pattern and the remaining subframes within the on duration having a second, different pattern.

In an embodiment, at least a part of a control region in the first pattern has a first numerology and at least a part of a control region in the second pattern has a second, different numerology, and the signal is transmitted using the first numerology.

In an embodiment, the signal is transmitted immediately preceding the on duration.

In an embodiment, the signal is transmitted before the on duration, with a gap between the signal and the on duration.

In an embodiment, the method further comprises: signaling the gap to the terminal device.

In an embodiment, as the signal, a periodic signal is used, which occurs first either earlier than or within the on duration, and then periodically for a given interval depending at least on a length of the on duration.

In an embodiment, the periodic signal occurs first in a subframe that precedes, and is closest in time domain to, the first subframe of the on duration based on a subframe offset, or in the first symbol of the on duration.

In an embodiment, the method further comprises: signaling the subframe offset and periodicity of the periodic signal to the terminal device.

In an embodiment, the periodic signal is automatically transmitted only when the access device has a data transmission to the terminal device.

In an embodiment, the signal is transmitted via two or more beams in two or more symbols, respectively. The method further comprises: receiving from the terminal device a feedback signal dependent on reception of the signal at the terminal device via the two or more beams; and selecting one of the two or more beams based on the feedback signal for subsequent transmission.

In an embodiment, the method further comprises, before the operation of transmitting: receiving a reference signal from the terminal device. The signal is transmitted in response to the reference signal.

In an embodiment, the method further comprises: determining a beam based on the reference signal, for transmitting the signal.

In an embodiment, the signal is transmitted only before or within an on duration subsequent to a long DRX cycle.

In an embodiment, the signal is transmitted only when Primary Synchronization Signal (PSS)/Secondary Synchronization Signal (SSS)/Physical Broadcast Channel (PBCH) or other reference signals are unavailable for the front-end and/or synchronization adjustment.

According to a second aspect of the present disclosure, an access device is provided. The access device comprises a transceiver, a processor and a memory. The memory comprises instructions executable by the processor whereby the access device is operative to perform the method according to the above first aspect.

According to a third aspect of the present disclosure, a computer readable storage medium is provided. The computer readable storage medium has computer program instructions stored thereon. The computer program instructions, when executed by a processor in an access device, cause the access device to perform the method according to the above first aspect.

According to a fourth aspect of the present disclosure, a method in a terminal device for facilitating Discontinuous Reception (DRX) is provided. The method comprises: receiving a signal from an access device before or within an on-duration of DRX; and performing front-end and/or synchronization adjustment based on the signal.

In an embodiment, the signal is received in the first one or more subframes within the on duration, the first one or more subframes having a first pattern and the remaining subframes within the on duration having a second, different pattern.

In an embodiment, at least a part of a control region in the first pattern has a first numerology and at least a part of a control region in the second pattern has a second, different numerology, and the signal is received using the first numerology.

In an embodiment, the signal is received immediately preceding the on duration.

In an embodiment, the signal is received before the on duration, with a gap between the signal and the on duration.

In an embodiment, the method further comprises: receiving a signal indicative of the gap from the access device.

In an embodiment, as the signal, a periodic signal is used, which occurs first either earlier than or within the on duration, and then periodically for a given interval depending at least on a length of the on duration.

In an embodiment, the periodic signal occurs first in a subframe that precedes, and is closest in time domain to, the first subframe of the on duration based on a subframe offset, or in the first symbol of the on duration.

In an embodiment, the method further comprises: receiving a signal indicative of the subframe offset and periodicity of the periodic signal from the access device.

In an embodiment, the signal is received via two or more beams in two or more symbols, respectively. The method further comprises: transmitting to the access device a feedback signal dependent on reception of the signal at the terminal device via the two or more beams.

In an embodiment, the method further comprises, before the operation of receiving: transmitting a reference signal to the access device. The signal is received as a response to the reference signal.

In an embodiment, the signal is received only before or within an on duration subsequent to a long DRX cycle.

In an embodiment, the signal is received only when Primary Synchronization Signal (PSS)/Secondary Synchronization Signal (SSS)/Physical Broadcast Channel (PBCH) or other reference signals are unavailable for the front-end and/or synchronization adjustment.

According to a fifth aspect of the present disclosure, a terminal device is provided. The terminal device comprises a transceiver, a processor and a memory. The memory comprises instructions executable by the processor whereby the terminal device is operative to perform the method according to the above fourth aspect.

According to a sixth aspect of the present disclosure, a computer readable storage medium is provided. The computer readable storage medium has computer program instructions stored thereon. The computer program instructions, when executed by a processor in a terminal device, cause the terminal device to perform the method according to the above fourth aspect.

With the embodiments of the present disclosure, an access device transmits a signal to a terminal device before or within an on-duration of DRX, such that the terminal device can perform front-end and/or synchronization adjustment based on the signal. In this way, the terminal device can have a timely adjustment of front-end and/or synchronization.

### BRIEF DESCRIPTION OF THE DRAWINGS

The above and other objects, features and advantages will be more apparent from the following description of embodiments with reference to the figures, in which:

FIG. 1 is a schematic diagram showing a DRX configuration;

FIG. 2 is a flowchart illustrating a method for facilitating DRX according to an embodiment of the present disclosure;

FIG. 3 is a schematic diagram showing an example of signal design according to an embodiment of the present disclosure;

FIG. 4 is a schematic diagram showing an example of signal design according to another embodiment of the present disclosure;

FIG. 5 is a schematic diagram showing an example of signal design according to another embodiment of the present disclosure;

FIG. 6 is a schematic diagram showing an example of signal design according to another embodiment of the present disclosure;

FIG. 7 is a schematic diagram showing an example of signal design according to another embodiment of the present disclosure;

FIG. 8 is a schematic diagram showing an example of signal design according to another embodiment of the present disclosure;

FIG. 9 is a flowchart illustrating a method for facilitating DRX according to an embodiment of the present disclosure;

FIG. 10 is a block diagram of an access device according to an embodiment of the present disclosure;

FIG. 11 is a block diagram of an access device according to another embodiment of the present disclosure;

FIG. 12 is a block diagram of a terminal device according to an embodiment of the present disclosure; and

FIG. 13 is a block diagram of a terminal device according to another embodiment of the present disclosure.

### DETAILED DESCRIPTION

The embodiments of the disclosure will be detailed below with reference to the drawings. It should be appreciated that the following embodiments are illustrative only, rather than limiting the scope of the disclosure.

FIG. 2 is a flowchart illustrating a method 200 for facilitating DRX according to an embodiment of the present disclosure. The method 200 can be performed at an access device, such as an evolved NodeB (eNB) or gNB or any kind of base station or access point used for radio communication with a terminal device.

At block S210, a signal is transmitted to the terminal device before or within an on-duration of DRX, for front-end and/or synchronization adjustment at the terminal device. In this context, the term “front-end” refers to AGC, Automatic Frequency Control (AFC), Lower Noise Amplifier (LNA), Automatic Fine Tuning (AFT), etc.

A terminal device herein can be any type of wireless device capable of communicating with an access device or another terminal device over radio signals. The terminal device may also be a radio communication device, a target device, Narrow Band Internet of Things (NB-loT) device, a Device-to-Device (D2D) UE, a machine type UE, or a UE capable of Machine-to-Machine (M2M) communication, a sensor equipped with a UE, an iPAD, a tablet, a mobile terminal, a smart phone, Laptop Embedded Equipped (LEE), Laptop Mounted Equipment (LME), Universal Serial Bus (USB) dongles, Customer Premises Equipment (CPE), etc.

The method 200 will be further explained with reference to the following examples.

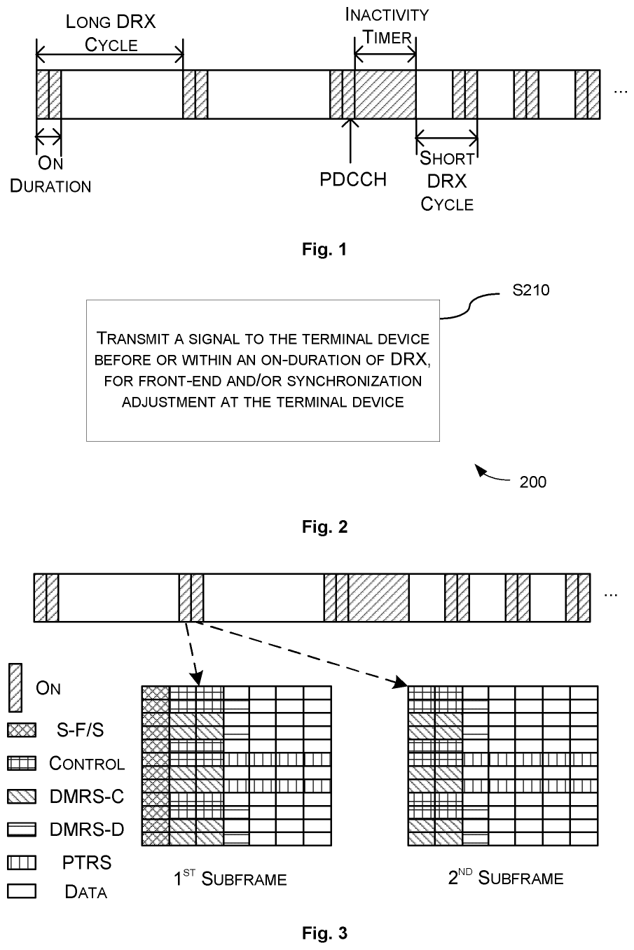

In an example, in the block S210, the signal can be transmitted in the first one or more subframes within the on duration. The first one or more subframes have a first pattern and the remaining subframes within the on duration have a second, different pattern. FIG. 3 is a schematic diagram showing an example of signal design according to an embodiment of the present disclosure. In this example, the first one or more subframes in the on duration have a first pattern containing a signal for front-end and/or synchronization adjustment at the terminal device, referred to as “S-F/S” hereinafter, and the remaining subframes in the on duration have a second, different pattern. The term “pattern” as used herein refers to positions of respective signals contained in a subframe in time, frequency, space and/or code domains, represented as e.g., symbol indices, subcarrier indices, antenna indices and/or code sequence indices, respectively. The upper part of FIG. 3 shows a DRX configuration, which is the same as FIG. 1. It is assumed here that each on duration contains two subframes. The lower part of FIG. 3 shows an exemplary format of each subframe in an on duration. It is further assumed here that each subframe contains seven (7) OFDM symbols in time domain (horizontal axis) and twelve (12) subcarriers in frequency domain (vertical axis). Each subframe contains a Demodulation Reference Signal (DMRS) for control (DMRS-C) and control information in its control region, and a DMRS for data (DMRS-D), a Phase Tracking Reference Signal (PTRS) and data information in its data region. As shown in FIG. 3, the first OFDM symbol in the first subframe carries an S-F/S. As a result, the two subframes have different patterns, with the data region beginning at the fourth OFDM symbol in the first subframe and at the third OFDM symbol in the second subframe. In an example, the patterns of the subframes in the on duration (particularly the position of the S-F/S) can be configured or signaled by the access device, or can be predefined.

It is to be noted here that, while FIG. 3 shows an example where the on duration contains two subframes and the first OFDM symbol in the first subframe is used for carrying the S-F/S, the present disclosure is not limited thereto. The on duration may contain more subframes and the first two or more OFDM symbols in each of the first two or more subframes can be used for carrying the S-F/S. This also applies to the examples and/or embodiments described below.

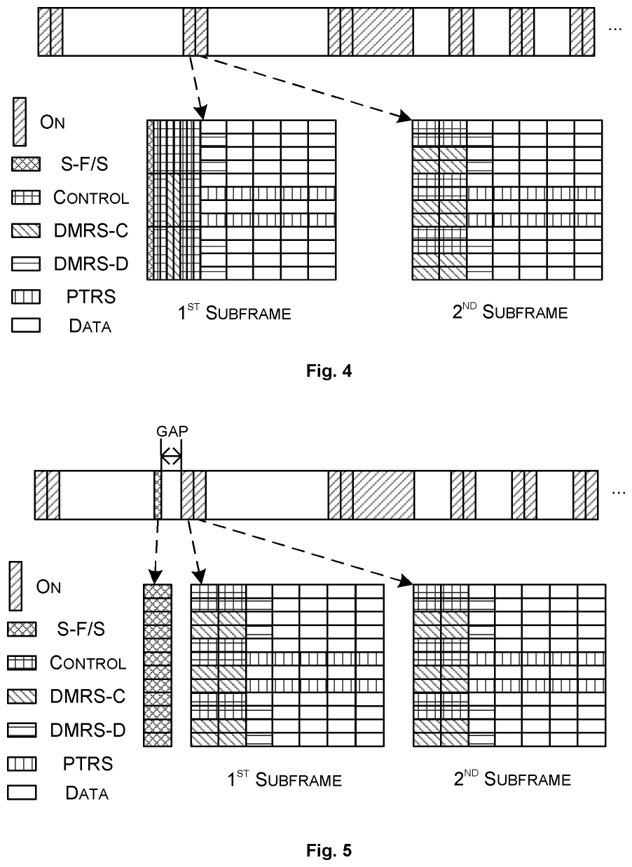

In an example, at least a part of a control region in the first pattern can have a first numerology and at least a part of a control region in the second pattern can have a second, different numerology. The S-F/S can be transmitted using the first numerology. FIG. 4 is a schematic diagram showing an example of signal design according to another embodiment of the present disclosure. The signal design in FIG. 4 is a variant of that in FIG. 3. In this example, the control region (or a part thereof) in the first pattern may have a different numerology than the control region (or a part thereof) in the second pattern. The term “numerology” refers to Cyclic Prefix (CP) length, subcarrier spacing and/or OFDM symbol length. As shown in FIG. 4, the control region of the first subframe uses e.g., 60 kHz subcarrier spacing, whereas the control region of the second subframe use e.g., 15 kHz subcarrier spacing. As a result, the OFDM symbol length in the control region of the first subframe is ¼ of that in the control region of the second subframe. In the example shown in FIG. 4, the first OFDM symbol is used for carrying an S-F/S. In this case, the overhead for the S-F/S is significantly reduced when compared with the example in FIG. 3.

In an example, the S-F/S can be transmitted immediately preceding the on duration. Alternatively, the S-F/S can be transmitted before the on duration, with a gap between the signal and the on duration. FIG. 5 is a schematic diagram showing an example of signal design according to another embodiment of the present disclosure. Instead of providing the S-F/S within the on duration in each of FIG. 3 and FIG. 4, in the example shown in FIG. 5, the S-F/S can be provided before the on duration, with or without a gap between the S-F/S and the on duration. When there is no gap, the S-F/S is provided immediately preceding the on duration. The gap allows two terminal devices having different DRX configurations to share the same S-F/S. For example, a terminal device, TD1, may have its on duration occurring 3 ms before the on duration for another terminal device, TD2. By setting the gap for TD1 to be 3 ms shorter than the gap for TD2, it is possible that the two terminal devices can share the same S-F/S. The gap can be configured or signaled by the access device or can be predefined. In addition to the S-F/S, other RSs such as Measurement RS (MRS) and Channel State Information Reference Signal (CSI-RS) can also be provided before the on duration in a similar way.

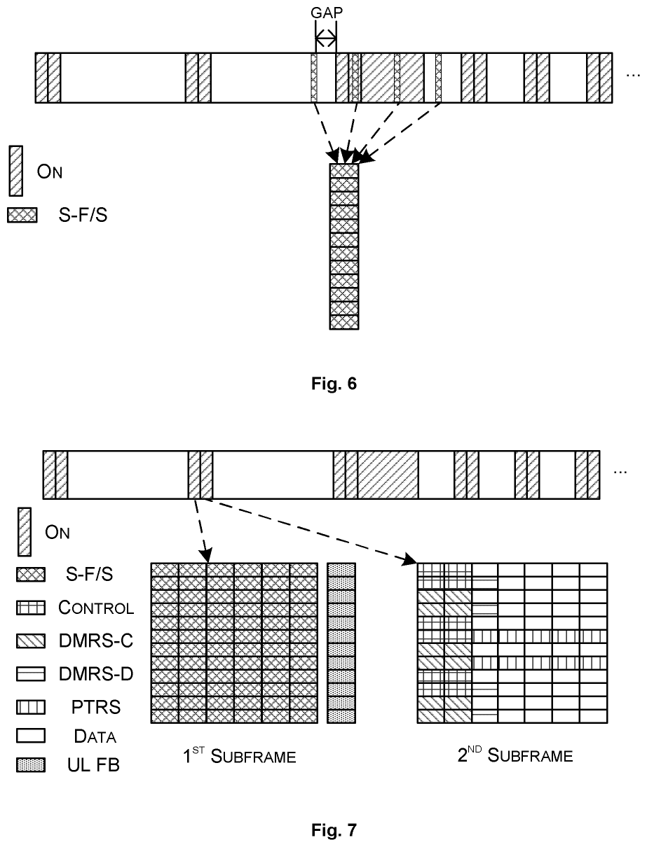

In an example, as the S-F/S, a periodic signal can be used, which occurs first either earlier than or within the on duration, and then periodically for a given interval depending at least on a length of the on duration. For instance, the periodic signal occurs first in a subframe that precedes, and is closest in time domain to, the first subframe of the on duration based on a subframe offset, or in the first symbol of the on duration. FIG. 6 is a schematic diagram showing an example of signal design according to another embodiment of the present disclosure. In this example, a periodic signal is provided as S-F/S. The first occurrence of the periodic signal can be earlier than the on duration and the transmission may be maintained for a given interval. The interval may be associated with the length of the on duration or may be associated with the terminal reception states. For example, when there is data transmission, the interval may be extended and when there is no data transmission, the interval may be ended at the end of the on duration. Such periodic signal can any signal for other purpose(s), e.g., it may be MRS or CSI-RS. As a specific example, the subframe offset and the periodicity of the periodic RS can be configured or signaled by the access device or can be predefined. When there is a transmission, the signal is automatically triggered. The access device may transmit the signal in the subframe indicated by the subframe offset that precedes, and is closest in time domain to, the first subframe of the on duration, and maintain the signal transmission for a given interval with the configured periodicity. Otherwise, the signal can be muted. Alternatively, the first occurrence of the periodic RS can be located within the first OFDM symbol of the on duration.

In an example, the S-F/S can be transmitted via two or more beams in two or more symbols, respectively. The access device can receive from the terminal device a feedback signal dependent on reception of the S-F/S at the terminal device via the two or more beams, and then select one of the two or more beams based on the feedback signal for subsequent transmission. FIG. 7 is a schematic diagram showing an example of signal design according to another embodiment of the present disclosure. In this example, the access device transmits S-F/S and the terminal device then measures the transmitted signal and sends a report to the access device, before an on-duration or within the first one or more subframes of the on-duration. The access device may transmit the S-F/S via different beams in different OFDM symbols to the terminal device. The terminal device then measures the received signal strengths from the respective beams, selects an optimal beam having the highest received signal strength for front-end and/or synchronization adjustment and transmits a feedback to the access device, indicating the selected beam. Accordingly, the access device can use the beam for the subsequent transmission. In this way, the access device can quickly determine the optimal beam to serve the terminal device. In the example shown in FIG. 7, the access device uses the first six (6) OFDM symbols in the first subframe to transmit S-F/S via six different beams, respectively. The last OFDM symbol carries the uplink feedback from the terminal device to the access device.

Here, the S-F/S can be control and/or data signal. In an example, the S-F/S can be MRS or CSI-RS or any other appropriate reference signals. The S-F/S can be coded with high redundancy for robustness.

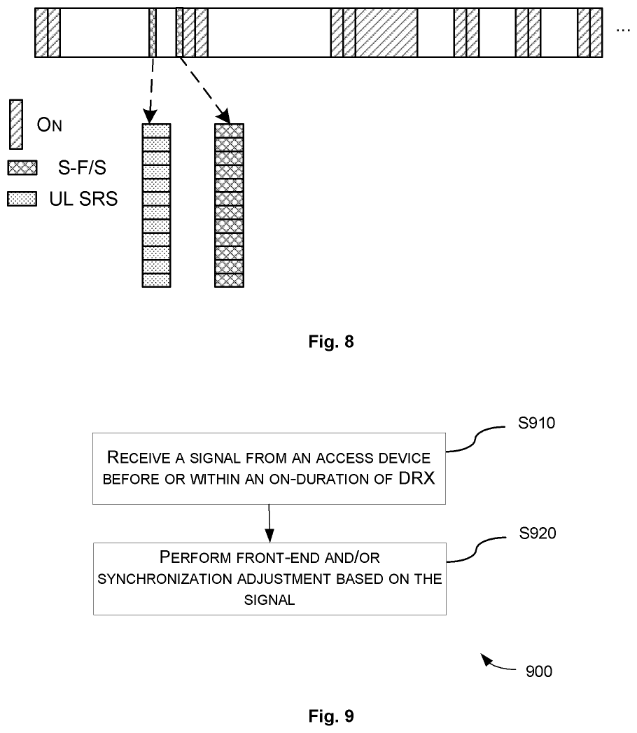

In an example, the access device can receive a reference signal from the terminal device and then, in the block S210, transmit the S-F/S to the terminal device in response to the reference signal. FIG. 8 is a schematic diagram showing an example of signal design according to another embodiment of the present disclosure. In this example, the terminal device transmits a signal to the access device first before an on-duration or within the first one or more subframes of the on-duration. Then, the access device can transmit an S-F/S to the terminal device in response to the signal. One example of the signal is Sounding Reference Signal (SRS). In an example, one or more SRSs can be transmitted via one or more beams. Upon receiving the SRS(s), the access device can determine an optimal beam to serve the terminal device based on channel reciprocity. Then, the access device can transmit an S-F/S to the terminal device via the optimal beam before or within the on duration. In an example, the SRS(s) can be transmitted in a time division manner to facilitate analog beamforming at the access device. The pattern of the SRS, i.e., its position in time/frequency/space/code domains, can be configurable or predefined. In an example, the condition triggering the terminal device to transmit the SRS can be configured via Radio Resource Control (RRC) signaling or a Medium Access Control (MAC) Control Element (CE).

It is to be noted here that, in each of the above examples or embodiments, the S-F/S can be adaptively provided. In an example, it is provided only before or within an on duration subsequent to a long DRX cycle. For short DRX cycle, it falls back to conventional operations. In an example, the S-F/S can be provided only when there is downlink control information (e.g., PDCCH) to be transmitted from the access device.

It can be appreciated that, in each of the above examples or embodiments, the S-F/S is not necessarily a dedicated reference signal. Instead, some other RSs, such as MRS or CSI-RS, or even data signals, can be (re)used as the S-F/S.

It can be appreciated that, in each of the above examples or embodiments, the transmission of the S-F/S may depend on other conditions. The conditions may be predefined or may be configured via RRC signaling/MAC CE or any other signaling. For example, when the carrier frequency is low (i.e, <6 GHz), the S-F/S may not be enabled; otherwise, the S-F/S can be enabled. As another example, when channel reciprocity is applicable, the S-F/S may not be enabled; otherwise, the S-F/S can be enabled.

In an example, a prioritization rule can be defined. In case another signal is available for the same purpose as the S-F/S, the S-F/S may not be transmitted. For example, when PSS/SSS/PBCH can be used for front-end and/or synchronization adjustment, e.g., at low frequency (i.e., <6 GHz), the PSS/SSS/PBCH can be prioritized over the S-F/S for front-end and/or synchronization adjustment. The access device may notify the terminal device whether to base the front-end and/or synchronization adjustment on PSS/SSS/PBCH or S-F/S. When the access device indicates the front-end and/or synchronization adjustment via another available signal, the S-F/S may not be transmitted. As another example, in case there are other RSs (such as MRS) that can be used for proper reception within a specified gap, the S-F/S can be discarded.

FIG. 9 is a flowchart illustrating a method 900 for facilitating DRX according to an embodiment of the present disclosure. The method 900 can be performed at a terminal device, e.g., a UE.

At block S910, a signal is received from an access device before or within an on-duration of DRX.

In an embodiment, as described above in connection with FIG. 3, the signal can be received in the first one or more subframes within the on duration, the first one or more subframes having a first pattern and the remaining subframes within the on duration having a second, different pattern, as described above in connection with FIG. 3.

In an embodiment, as described above in connection with FIG. 4, at least a part of a control region in the first pattern can have a first numerology and at least a part of a control region in the second pattern can have a second, different numerology, and the signal can be received using the first numerology.

In an embodiment, as described above in connection with FIG. 5, the signal can be received immediately preceding the on duration. Alternatively, the signal can be received before the on duration, with a gap between the signal and the on duration. In an embodiment, the method 900 may further comprise: receiving a signal indicative of the gap from the access device.

In an embodiment, as described above in connection with FIG. 6, a periodic signal can be used as the signal, which occurs first either earlier than or within the on duration, and then periodically for a given interval depending at least on a length of the on duration.

In an embodiment, the periodic signal may occur first in a subframe that precedes, and is closest in time domain to, the first subframe of the on duration based on a subframe offset, or in the first symbol of the on duration.

In an embodiment, the method 900 may further comprise: receiving a signal indicative of the subframe offset and periodicity of the periodic signal from the access device.

In an embodiment, as described above in connection with FIG. 7, the signal can be received via two or more beams in two or more symbols, respectively. The method 900 may further comprise: transmitting to the access device a feedback signal dependent on reception of the signal at the terminal device via the two or more beams.

In an embodiment, as described above in connection with FIG. 8, the method 900 may further comprise, before the block S910: transmitting a reference signal to the access device. The signal can be received as a response to the reference signal in the block S910. In an example, the reference signal can be used by the access device to determine an optimal beam for transmitting the signal.

In an embodiment, the signal is received only before or within an on duration subsequent to a long DRX cycle.

In an embodiment, the signal can be received only when Primary Synchronization Signal (PSS)/Secondary Synchronization Signal (SSS)/Physical Broadcast Channel (PBCH) or other reference signals are unavailable for the front-end and/or synchronization adjustment.

At block S920, front-end and/or synchronization adjustment is performed based on the signal. For example, the terminal device may perform AGC and/or AFC based on the signal. Additionally or alternatively, the terminal device can perform frequency estimation/tracking, timing estimation/tracking, phase noise estimation/tracking, Doppler estimation/tracking, and/or spatial domain characteristic estimation/tracking, based on the signal. Then, based on the result of the frequency, timing, phase noise, Doppler and/or spatial domain characteristic estimation/tracking, the terminal device can make compensation for signals received subsequently to reduce Inter-Carrier Interference (ICI) and/or Inter-Symbol Interference (ISI), thereby improving the data and/or control channel reception performance.

The above examples described in connection with FIGS. 3-8 also apply to the method 900.

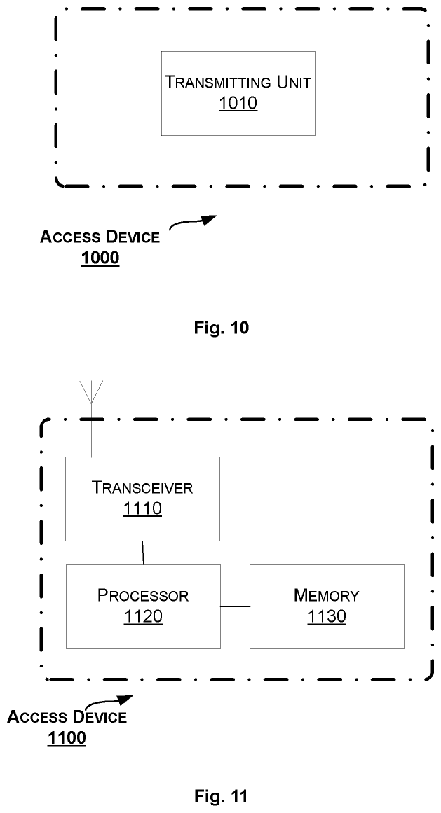

Correspondingly to the method 200 as described above, an access device is provided. FIG. 10 is a block diagram of an access device 1000 for facilitating DRX according to an embodiment of the present disclosure.

As shown in FIG. 10, the access device 1000 includes a transmitting unit 1010. The transmitting unit 1010 is configured to transmit a signal to the terminal device before or within an on-duration of DRX, for front-end and/or synchronization adjustment at the terminal device.

In an embodiment, the transmitting unit 1010 is configured to transmit the signal in the first one or more subframes within the on duration, the first one or more subframes having a first pattern and the remaining subframes within the on duration having a second, different pattern.

In an embodiment, at least a part of a control region in the first pattern has a first numerology and at least a part of a control region in the second pattern has a second, different numerology, and the transmitting unit 110 is configured to transmit the signal using the first numerology.

In an embodiment, the transmitting unit 1010 is configured to transmit the signal immediately preceding the on duration.

In an embodiment, the transmitting unit 1010 is configured to transmit the signal before the on duration, with a gap between the signal and the on duration.

In an embodiment, the transmitting unit 1010 is further configured to signal the gap to the terminal device.

In an embodiment, as the signal, a periodic signal is used, which occurs first either earlier than or within the on duration, and then periodically for a given interval depending at least on a length of the on duration.

In an embodiment, the periodic signal occurs first in a subframe that precedes, and is closest in time domain to, the first subframe of the on duration based on a subframe offset, or in the first symbol of the on duration.

In an embodiment, the transmitting unit 1010 is configured to signal the subframe offset and periodicity of the periodic signal to the terminal device.

In an embodiment, the periodic signal is automatically transmitted only when the access device has a data transmission to the terminal device.

In an embodiment, the transmitting unit 1010 is configured to transmit the signal via two or more beams in two or more symbols, respectively. The access device 1000 further comprises: a receiving unit configured to receive from the terminal device a feedback signal dependent on reception of the signal at the terminal device via the two or more beams; and a selecting unit configured to select one of the two or more beams based on the feedback signal for subsequent transmission.

In an embodiment, the access device 1000 further comprises a receiving unit configured to receive a reference signal from the terminal device. The transmitting unit 1010 is configured to transmit the signal in response to the reference signal.

In an embodiment, the access device 1000 further comprises: a determining unit configured to determine a beam based on the reference signal, for transmitting the signal. The transmitting unit 1010 is configured to transmit the signal via the determined beam.

In an embodiment, the transmitting unit 1010 is configured to transmit the signal only before or within an on duration subsequent to a long DRX cycle.

In an embodiment, the transmitting unit 1010 is configured to transmit the signal only when Primary Synchronization Signal (PSS)/Secondary Synchronization Signal (SSS)/Physical Broadcast Channel (PBCH) or other reference signals are unavailable for the front-end and/or synchronization adjustment.

The transmitting unit 1010, and optionally the receiving unit, the selecting unit and the determining unit, can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 2.

FIG. 11 is a block diagram of an access device 1100 according to another embodiment of the present disclosure. The access device 1100 can be provided for facilitating DRX.

The access device 1100 includes a transceiver 1110, a processor 1120 and a memory 1130. The memory 1130 contains instructions executable by the processor 1120 whereby the access device 1100 is operative to perform the actions, e.g., of the procedure described earlier in conjunction with FIG. 2. Particularly, the memory 1130 contains instructions executable by the processor 1120 whereby the access device 1100 is operative to transmit a signal to the terminal device before or within an on-duration of DRX, for front-end and/or synchronization adjustment at the terminal device.

In an embodiment, the signal is transmitted in the first one or more subframes within the on duration, the first one or more subframes having a first pattern and the remaining subframes within the on duration having a second, different pattern.

In an embodiment, at least a part of a control region in the first pattern has a first numerology and at least a part of a control region in the second pattern has a second, different numerology, and the signal is transmitted using the first numerology.

In an embodiment, the signal is transmitted immediately preceding the on duration.

In an embodiment, the signal is transmitted before the on duration, with a gap between the signal and the on duration.

In an embodiment, the memory 1130 further contains instructions executable by the processor 1120 whereby the access device 1100 is operative to: signal the gap to the terminal device.

In an embodiment, as the signal, a periodic signal is used, which occurs first either earlier than or within the on duration, and then periodically for a given interval depending at least on a length of the on duration.

In an embodiment, the periodic signal occurs first in a subframe that precedes, and is closest in time domain to, the first subframe of the on duration based on a subframe offset, or in the first symbol of the on duration.

In an embodiment, the memory 1130 further contains instructions executable by the processor 1120 whereby the access device 1100 is operative to: signal the subframe offset and periodicity of the periodic signal to the terminal device.

In an embodiment, the periodic signal is automatically transmitted only when the access device has a data transmission to the terminal device.

In an embodiment, the signal is transmitted via two or more beams in two or more symbols, respectively. The memory 1130 further contains instructions executable by the processor 1120 whereby the access device 1100 is operative to: receive from the terminal device a feedback signal dependent on reception of the signal at the terminal device via the two or more beams; and select one of the two or more beams based on the feedback signal for subsequent transmission.

In an embodiment, the memory 1130 further contains instructions executable by the processor 1120 whereby the access device 1100 is operative to: before the operation of transmitting: receive a reference signal from the terminal device. The signal is transmitted in response to the reference signal.

In an embodiment, the memory 1130 further contains instructions executable by the processor 1120 whereby the access device 1100 is operative to: determine a beam based on the reference signal, for transmitting the signal.

In an embodiment, the signal is transmitted only before or within an on duration subsequent to a long DRX cycle.

In an embodiment, the signal is transmitted only when Primary Synchronization Signal (PSS)/Secondary Synchronization Signal (SSS)/Physical Broadcast Channel (PBCH) or other reference signals are unavailable for the front-end and/or synchronization adjustment.

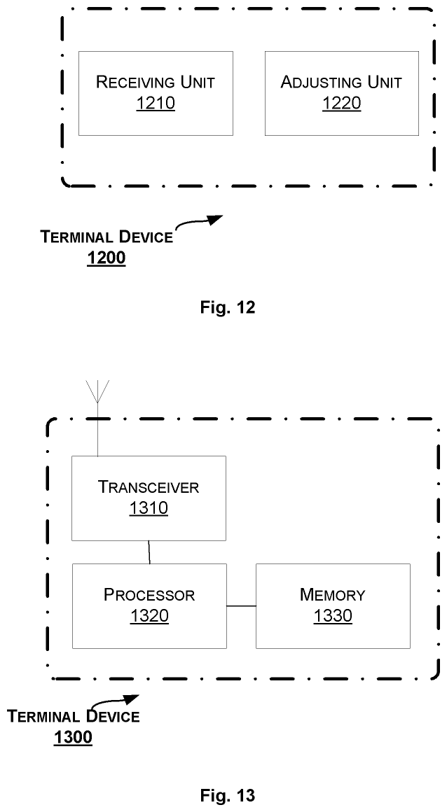

Correspondingly to the method 900 as described above, a terminal device is provided. FIG. 12 is a block diagram of a terminal device 1200 for facilitating DRX according to an embodiment of the present disclosure.

As shown in FIG. 12, the terminal device 1200 includes a receiving unit 1210 and an adjusting unit 1220. The receiving unit 1210 is configured to receive a signal from an access device before or within an on-duration of DRX. The adjusting unit 1220 is configured to perform front-end and/or synchronization adjustment based on the signal.

In an embodiment, the receiving unit 1210 is configured to receive the signal in the first one or more subframes within the on duration, the first one or more subframes having a first pattern and the remaining subframes within the on duration having a second, different pattern.

In an embodiment, at least a part of a control region in the first pattern has a first numerology and at least a part of a control region in the second pattern has a second, different numerology, and the receiving unit 1210 is configured to receive the signal using the first numerology.

In an embodiment, the receiving unit 1210 is configured to receive the signal immediately preceding the on duration.

In an embodiment, the receiving unit 1210 is configured to receive the signal before the on duration, with a gap between the signal and the on duration.

In an embodiment, the receiving unit 1210 is further configured to receive a signal indicative of the gap from the access device.

In an embodiment, as the signal, a periodic signal is used, which occurs first either earlier than or within the on duration, and then periodically for a given interval depending at least on a length of the on duration.

In an embodiment, the periodic signal occurs first in a subframe that precedes, and is closest in time domain to, the first subframe of the on duration based on a subframe offset, or in the first symbol of the on duration.

In an embodiment, the receiving unit 1210 is configured to receive a signal indicative of the subframe offset and periodicity of the periodic signal from the access device.

In an embodiment, the receiving unit 1210 is configured to receive the signal via two or more beams in two or more symbols, respectively. The terminal device 1200 further comprises: a transmitting unit configured to transmit to the access device a feedback signal dependent on reception of the signal at the terminal device via the two or more beams.

In an embodiment, the terminal device 1200 further comprises: a transmitting unit configured to transmit a reference signal to the access device. The receiving unit 1210 is configured to receive the signal as a response to the reference signal.

In an embodiment, the receiving unit 1210 is configured to receive the signal only before or within an on duration subsequent to a long DRX cycle.

In an embodiment, the receiving unit 1210 is configured to receive the signal only when Primary Synchronization Signal (PSS)/Secondary Synchronization Signal

(SSS)/Physical Broadcast Channel (PBCH) or other reference signals are unavailable for the front-end and/or synchronization adjustment.

The above units 1210 and 1220, and optionally the transmitting unit, can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 9.

FIG. 13 is a block diagram of a terminal device 1300 according to another embodiment of the present disclosure. The terminal device 1300 can be provided for facilitating DRX.

The terminal device 1300 includes a transceiver 1310, a processor 1320 and a memory 1330. The memory 1330 contains instructions executable by the processor 1320 whereby the terminal device 1300 is operative to perform the actions, e.g., of the procedure described earlier in conjunction with FIG. 9. Particularly, the memory 1330 contains instructions executable by the processor 1320 whereby the terminal device 1300 is operative to receive a signal from an access device before or within an on-duration of DRX and perform front-end and/or synchronization adjustment based on the signal.

In an embodiment, the signal is received in the first one or more subframes within the on duration, the first one or more subframes having a first pattern and the remaining subframes within the on duration having a second, different pattern.

In an embodiment, at least a part of a control region in the first pattern has a first numerology and at least a part of a control region in the second pattern has a second, different numerology, and the signal is received using the first numerology.

In an embodiment, the signal is received immediately preceding the on duration.

In an embodiment, the signal is received before the on duration, with a gap between the signal and the on duration.

In an embodiment, the memory 1330 further contains instructions executable by the processor 1320 whereby the terminal device 1300 is operative to: receive a signal indicative of the gap from the access device.

In an embodiment, as the signal, a periodic signal is used, which occurs first either earlier than or within the on duration, and then periodically for a given interval depending at least on a length of the on duration.

In an embodiment, the periodic signal occurs first in a subframe that precedes, and is closest in time domain to, the first subframe of the on duration based on a subframe offset, or in the first symbol of the on duration.

In an embodiment, the memory 1330 further contains instructions executable by the processor 1320 whereby the terminal device 1300 is operative to: receive a signal indicative of the subframe offset and periodicity of the periodic signal from the access device.

In an embodiment, the signal is received via two or more beams in two or more symbols, respectively. The memory 1330 further contains instructions executable by the processor 1320 whereby the terminal device 1300 is operative to: transmit to the access device a feedback signal dependent on reception of the signal at the terminal device via the two or more beams.

In an embodiment, the memory 1330 further contains instructions executable by the processor 1320 whereby the terminal device 1300 is operative to, before the operation of receiving: transmit a reference signal to the access device. The signal is received as a response to the reference signal.

In an embodiment, the signal is received only before or within an on duration subsequent to a long DRX cycle.

In an embodiment, the signal is received only when Primary Synchronization Signal (PSS)/Secondary Synchronization Signal (SSS)/Physical Broadcast Channel (PBCH) or other reference signals are unavailable for the front-end and/or synchronization adjustment.

The present disclosure also provides at least one computer program product in the form of a non-volatile or volatile memory, e.g., a non-transitory computer readable storage medium, an Electrically Erasable Programmable Read-Only Memory (EEPROM), a flash memory and a hard drive. The computer program product includes a computer program. The computer program includes: code/computer readable instructions, which when executed by the processor 1120 causes the access device 1100 to perform the actions, e.g., of the procedure described earlier in conjunction with FIG. 2; or code/computer readable instructions, which when executed by the processor 1320 causes the terminal device 1300 to perform the actions, e.g., of the procedure described earlier in conjunction with FIG. 9.

The computer program product may be configured as a computer program code structured in computer program modules. The computer program modules could essentially perform the actions of the flow illustrated in FIG. 2 or 9.

The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor. The computer program product may comprise a non-transitory computer readable storage medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories.

The disclosure has been described above with reference to embodiments thereof. It should be understood that various modifications, alternations and additions can be made by those skilled in the art without departing from the spirits and scope of the disclosure. Therefore, the scope of the disclosure is not limited to the above particular embodiments but only defined by the claims as attached.

1. A method in an access device for facilitating Discontinuous Reception (DRX) at a terminal device, comprising:
transmitting a signal to the terminal device before or within an on-duration of DRX, for front-end and/or synchronization adjustment at the terminal device.

2-4. (canceled)

5. The method of claim 1, wherein the signal is transmitted before the on duration, with a gap between the signal and the on duration.

6. The method of claim 5, further comprising:
signaling the gap to the terminal device.

7-15. (canceled)

16. An access device, comprising a transceiver a processor and a memory, the memory comprising instructions executable by the processor to:
transmit a signal to the terminal device before or within an on-duration of DRX, for front-end and/or synchronization adjustment at the terminal device.

17. A computer readable storage medium having computer program instructions stored thereon, the computer program instructions, when executed by a processor in an access device, cause the access device to:
transmit a signal to the terminal device before or within an on-duration of DRX, for front-end and/or synchronization adjustment at the terminal device.

18. A method in a terminal device for facilitating Discontinuous Reception (DRX), comprising:
receiving a signal from an access device before or within an on-duration of DRX; and
performing front-end and/or synchronization adjustment based on the signal.

19-21. (canceled)

22. The method of claim 18, wherein the signal is received before the on duration, with a gap between the signal and the on duration.

23. The method of claim 22, further comprising:
receiving a signal indicative of the gap from the access device.

24-30. (canceled)

31. A terminal device, comprising a transceiver, a processor and a memory, the memory comprising instructions executable by the processor to:
receive a signal from an access device before or within an on-duration of DRX; and
perform front-end and/or synchronization adjustment based on the signal.

32. A computer readable storage medium having computer program instructions stored thereon, the computer program instructions, when executed by a processor in a terminal device, cause the terminal device to:
receive a signal from an access device before or within an on-duration of DRX; and
perform front-end and/or synchronization adjustment based on the signal.
